(19) United States
(12) Patent Application Publication
(10) Pub. No.: US 2005/0197956 A1
(43) Pub. Date: Sep. 8, 2005

(54) Cost recovery billing system

(76) Inventor: Terry L. Henley, Troy, OH (US)

Correspondence Address: A PATENT LAWYER CORP, PC;R WILLIAM GRAHAM, 22 S ST CLAIR ST, DAYTON, OH, 45402, US

(21) Appl. No.: 10/793,206

(22) Filed: Mar. 4, 2004

(51) Int. Cl. G06F 17/60

(52) U.S. Cl. 705/40

(57) ABSTRACT

A cost recovery billing system for a responder department includes a computer based device having cost recovery billing software operably disposed thereon for purposes of billing a responsible party for a false alarm or an at-fault accident. The billing software is operably associated with a responder department in a manner to receive responsible party data relating to a false alarm or accident for purposes of enabling billing of the responsible party.

### BACKGROUND OF THE INVENTION

1. Field of the Invention

The present invention relates to the recovery of costs associated with responding to emergency situations. More particularly, the present invention relates to a cost recovery billing system for costs associated with responding to an emergency.

2. Background of the Invention

New homes and businesses are being designed with built-in alarm systems. The increased residential and business installation and use of alarm systems as well as unnecessary emergency calls have dramatically increased the frequency of false alarm dispatches for emergency vehicles. In some communities, dispatches have tripled. Inexperience with these systems has driven false alarm dispatches to nuisance levels and increased emergency departmental costs. In addition, the safety of the citizens and “responders”, i.e., officers, fire department personnel and other emergency attendants are placed at a higher traffic risk.

Alarm companies collect a monthly fee for monitoring security systems electronically and initiating the dispatch of responders to the residence or business location. These alarm companies are in essence marketing the responder's services without reimbursing the responder.

Responders are further burdened by significant un-recouped expense in responding to an “at-fault” accident where there is commonly one or more responsible party. The responsible party typically does not pay for the responder's services.

Thus, false alarms and at-fault accidents place an unnecessary expense on the responder's department. Accordingly, there is also a need for providing a system which enables recovery for such false alarms and at-fault accidents. There is need to reduce or deter false alarms. The present invention offers a cost recovery billing system which solves or at least reduces the impact of the above-identified problems and other problems associated with responding to false alarms and at-fault accidents.

### SUMMARY OF THE INVENTION

An object of the present invention is to aid in recovering responder department's costs associated with false alarms and at-fault accidents.

Another object of the present invention is to reduce or deter false alarms.

Another object of the invention is to provide for a cost recovery billing system which places responder department costs on the responsible party.

It is an object to reduce police and fire department costs.

An additional object of the present invention is to provide a cost recovery billing system which will reduce the amount of administrative collection work for police and fire departments.

Another object of the present invention is to provide a cost recovery billing system which solves or at least reduces the impact of the above-identified problems and other problems associated with responding to false alarms and at-fault accidents.

Accordingly, one embodiment of the present invention is directed to a cost recovery billing system which includes a computer based device having cost recovery billing software operably disposed thereon for purposes of billing a responsible party for a false alarm or at-fault accident. The billing software is operably associated with a responder department in a manner to receive responsible party data relating to a false alarm or accident for purposes of enabling billing of the responsible party.

Billing software is operably associated with a service provider database, wherein the service provider database includes a contact data listing which can include telephone number(s) having associated street addresses and associated names. The service provider can be a telephone company, an alarm monitoring company or a credit card company with whom the responsible party has an established account.

Preferably, when a party calls for a responder, the billing software includes means for receiving contact data of the responsible party (which can be automatically performed). The billing software compares the provided contact data with the contact data listing in the service provider database and verifies the responsible party contact data for purposes of billing.

Upon verifying the provided contact data, the billing software assigns a responder charge to be made by the responsible party through one of the service providers using the provided contact data. For example, the contact data listing can be characterized as a listing of parties' telephone numbers, names, and addresses having an established account with a telephone service provider. Thus, the party requesting the responder is billed through the party's established telephone account. Likewise, an alarm company or credit card company or responder account can be used.

These and various other advantages and features of novelty which characterize the invention are pointed out with particularity in the claims annexed hereto and forming a part hereof. However, for a better understanding of the invention, its advantages and objects attained by its use, reference should be had to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram of an embodiment of the present invention.

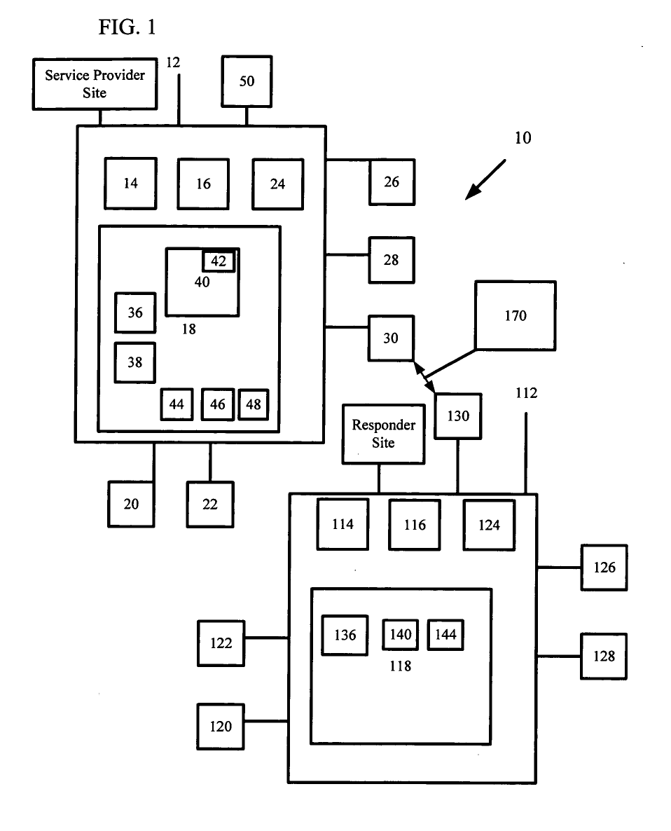

### DETAILED DESCRIPTION

By so providing the instant invention as described herein, a reduction in false alarms can be achieved and safety maximized. The instant invention effectively recovers costs associated with false alarms and at-fault accidents.

The invention can also progressively monitor those who habitually send the fire and police departments to such sites. The invention can receive contact data of the responsible party and place the resultant charge for the dispatched personnel on the responsible party's telephone bill, for example, for payment through the party's telephone company or other engaged responsible party/service provider account. The invention can be programmatically set to maintain the status of every alarm call and systematically bills the responsible party based on predetermined criteria, such as a determination that the alarm was false or the accident was an at-fault type or such other criteria established by the governing regulations of the party's domicile or place of business.

The invention protects taxpayer investment by recovering alternative funds from the responsible party. Alarm dispatches will likely decline in number by holding habitual violators responsible through a user fee program provided by the invention. Responder personnel and citizens are at reduced traffic risk by avoiding unnecessary dispatches. Citizens can receive expected response on real emergencies by reducing the number of responders that are dispatched because of false alarms.

The contact data needed to bill the false alarms and at-fault accidents can be routed electronically to the cost recovery billing software. Responder departments are operably associated with the billing cost recovery system of the instant invention to communicate an electronic record of the false alarm or at-fault accident from the responder department and bill the charge on the responsible party's telephone bill, for example, for payment through the responsible party's local telephone provider.

Referring now to the drawing, the cost recovery billing system is generally referred to by the numeral 10. The system 10 includes a computer and which can include and is capable of running standard operating system software such as Windows, Linux, or Unix.

The system 10 can include a conventional computer 12 having a central processor (CPU) 14, random memory 16, permanent memory 18 (e.g., hard or fixed disk, optical disk, magneto-optical disk, or flash memory), and can include a keyboard 20, a mouse 22 (or like pointing device), a clock 24 and a display or screen device 26, otherwise known in the art to lend functionality to the computer 12. Processor 14 is operably associated with memory 16 for storing frequently accessed information. One or more input/output device(s) 28, such as a printer can be included. The computer 12 can preferably include a communication link 30 which can be a LAN, WAN, modem connection or other communication line, for example. Operably residing on the computer 12 is operating system software 36 and can be, for example, of a type described above or is known in the art. The operating software 36 is preferably stored in memory 18, and can include a one or more application programs as is known in the art.

Preferably, another computer 112 can be provided which has a central processor (CPU) 114, random memory 116, permanent memory 118, and can include a keyboard 120, a mouse 122, a clock 124 and a display or screen device 126, input/output device(s) 128, and a communication link 130, for example. Residing on the computer 112 is operating software 136 and includes a one or more applications as above. It should be noted that the invention can be modified, e.g., to add or delete devices, such as device 28, so long as the ability to perform the intended objectives of the invention can be carried out.

The computer 12 can be located at a remote site from the responder's site, which can be at a service provider's site, such as an alarm monitoring company site, telephone company site or credit card site. The computer 112 can be located at the responder site, e.g., at a police or fire department.

Cost recovery billing software 38 is operably associated with a service provider database 40 which is shown here on a memory 18. While shown here on a service provider site, it is understood that the cost recovery billing software 38 can be on a remotely located computer and work in cooperation with conventional browser software. The service provider database 40 includes a contact data listing 42 of telephone numbers each having associated street addresses and associated names.

The cost recovery billing software 38 is capable of receiving contact data 140 which is shown here, by way of example, on computer 112 and comparing the provided contact data 140 with the contact data listing 42 of telephone numbers, addresses and names in the service provider database 40. In this example, the cost recovery billing software 38 generates and communicates a signal to the computer 112 indicative of verifying the provided contact data 140 is accurate for purposes of billing. It can also be that the billing software 38 obtains the contact data 140 automatically, such as sensing the incoming telephone number through caller id, for example, and perform the comparison and verification.

Upon verifying the contact data 140, the cost recovery billing software 38 assigns responder charges to be made by the party with the provided contact data 140. In a preferred embodiment, each responsible party which is in contact data listing 42 is on an established account with a service provider. The cost recovery billing software 38 is equipped to bill the predetermined responder charges through the established account.

It is noted that the cost recovery billing software 38 can be operatively residing on either or both of the computers 12 and 112. It is further contemplated that the cost recovery billing software 38 can be web-based and that browser technology can be employed to employ the use of the software 38. Thus, the location of the cost recovery billing software 38 can be so situated to carry out the invention.

The cost recovery billing software 38 is capable of associating, logging and storing of contact data 140 into a client data file 44 via a client screen which displays client name field, contact name field, street address field, city address field, state zip code field, country field, work, fax and home telephone fields and creates a unique identification for each client. Likewise, the cost recovery billing software 38 provides entry of responder data 144 into a responder data file 46 via a service provider screen having company name field, service provider name field, street address field, city address field, state zip code field, country field, work, fax and home telephone fields, predetermined types of charge fields and unique identification for the service provider is permitted and stored in the responder data file 46. Further, the cost recovery billing software 38 provides for associating and accruing charges of the responder's services/goods obtained or used by a particular client to be billed and writing and storing such all accrued charges into a billing data file 48.

Again, the cost recovery billing software 38 can preferably be automatically initiated electronically by identifying the party's telephone number (responsible party provided data) and comparing this number to a service provider's database (e.g., a telephone company's database having the responsible party as a client). Optionally, the cost recovery billing software 38 provides displays a screen (e.g., a windows-based screen) on the monitor 126 prompting the responder to enter the responsible party contact data 140. The responder can cancel the operation for no-fault alarm or accident. The cost recovery billing software 38 provides for the screen to minimize or for exiting of the cost recovery billing software 38 upon cancellation of operation. Upon logging the responsible party contact data 140, cost recovery billing software 38 performs a verification of the contact data 140 by comparing against the contact data listing 42 and displays a screen verifying the responsible party contact data 140. If verified, the cost recovery billing software 38 enables predetermined types of services/goods to be accrued through to the responsible party billing data file 48 as set forth above.

If not confirmed, cost recovery billing software 38 generates a call signal to an alternative billing mechanism 170 (such as a billing call center), wherein the alternative billing center 170 is equipped to handle credit card billing or other suitable billing arrangement between the responsible party and the responder.

The cost recovery billing software 38 is preferably continuously running to receive contact data 140 and assign charges to the responsible party billing data file 44 and in turn, the cost recovery billing software 38 enables the generation of an invoice (by way of any suitable printing means) to the client on behalf of the responder. Herein, the invoice generated would include listing the responsible party data and responder data with itemized services/goods provided.

The above described embodiment is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

1. A cost recovery billing system for a responder department, which includes:
a computer based device having cost recovery billing software operably disposed thereon for purposes of billing a responsible party for one of a false alarm and an at-fault accident, said billing software operably associated with a responder department in a manner to obtain contact data of a responsible party relating to one of said false alarm and said accident for purposes of enabling billing of the responsible party.

2. The cost recovery billing system of claim 1, wherein said billing software is operably associated with a service provider database, wherein the service provider database includes a contact data listing of a plurality of contacts and means for comparing said responsible party contact data with said contact data listing in said service provider database and verifying responsible party contact data for purposes of billing.

3. The cost recovery billing system of claim 2, wherein said contact data listing includes a telephone number having an associated street address and associated name for each said contact therein.

4. The cost recovery billing system of claim 2, wherein said service provider is characterized to be a company with whom said responsible party has an established account.

5. The cost recovery billing system of claim 4, wherein said service provider includes one of a telephone company, an alarm monitoring company, a credit card company and a responder company.

6. The cost recovery billing system of claim 5, whereupon verifying said responsible party contact data, said billing software assigns a responder charge to be made by the responsible party through said service provider using the provided contact data.

7. The cost recovery billing system of claim 2, wherein said cost recovery billing software includes means for automatically obtaining said responsible party contact data.

8. The cost recovery billing system of claim 7, wherein said billing software is operably associated with a service provider database, wherein the service provider database includes a contact data listing of a plurality of contacts and means for comparing said responsible party contact data with said contact data listing in said service provider database and verifying responsible party contact data for purposes of billing.

9. A method of billing a party through a cost recovery billing system for a responder department, which includes the steps of:
obtaining said contact data at through a responder; and
transmitting said contact data to a computer based device having cost recovery billing software operably disposed thereon for purposes of billing a responsible party for one of a false alarm and an at-fault accident, said billing software operably associated with said responder department in a manner to receive contact data of a responsible party relating to one of said false alarm and said accident for purposes of enabling billing of the responsible party.

10. The method of claim 9, wherein said billing software is operably associated with a service provider database, wherein the service provider database includes a contact data listing of a plurality of contacts and further includes the steps of comparing said obtained contact data with said contact data listing in said service provider database and verifying said obtained contact data for purposes of billing.

11. The method of claim 10, wherein said contact data listing includes a telephone number having an associated street address and associated name for each said contact therein.

12. The method of claim 10, wherein said service provider is characterized to be a company with whom said responsible party has an established account.

13. The method of claim 12, wherein said service provider includes one of a telephone company, an alarm monitoring company, a credit card company and a responder company.

14. The method of claim 12, which further includes the step of assigning a responder charge to be made by the responsible party through said service provider using the provided contact data and said billing software.

15. The method of claim 12, which further includes the step of automatically obtaining said contact data using said billing software.

16. The method of claim 15, wherein said billing software is operably associated with a service provider database, wherein the service provider database includes a contact data listing of a plurality of contacts and further includes the steps of comparing said obtained contact data with said contact data listing in said service provider database and verifying said obtained contact data for purposes of billing.
